(19) United States
(12) Patent Application Publication
(10) Pub. No.: US 2025/0299381 A1
(43) Pub. Date: Sep. 25, 2025

(54) INFORMATION PROCESSING APPARATUS AND FEATURE AMOUNT INFERENCE METHOD

(71) Applicant: KABUSHIKI KAISHA TOSHIBA, Tokyo (JP)

(72) Inventors: Shojun NAKAYAMA, Yokohama Kanagawa (JP); Osamu YAMAGUCHI, Yokohama Kanagawa (JP); Yushiro KASHIMOTO, Yokohama Kanagawa (JP); Gaku MINAMOTO, Kawasaki Kanagawa (JP); Toshihiro TAKAHASHI, Nerima Tokyo (JP)

(73) Assignee: KABUSHIKI KAISHA TOSHIBA, Tokyo (JP)

(21) Appl. No.: 19/065,093

(22) Filed: Feb. 27, 2025

(30) Foreign Application Priority Data
Mar. 19, 2024 (JP) 2024-044246

(51) Int. Cl. G06T 11/00; G06F 40/284

(52) U.S. Cl. CPC G06T 11/00; G06F 40/284

(57) ABSTRACT

An information processing apparatus according to an embodiment includes a personalized feature amount inference unit configured to infer a second prompt token sequence related to a second feature amount on the basis of data related to background information of a person having an attribute close to an attribute of a first user, among data included in a background information database accumulating background information in which attribute information related to an attribute of a person, a feature amount input by the person, and a behavior history related to an action of the person with respect to a product generated on the basis of the feature amount are associated with each other, and a first feature amount input by the first user.

### CROSS-REFERENCE TO RELATED APPLICATION

This application is based upon and claims the benefit of priority from Japanese Patent Application No. 2024-044246,filed Mar. 19, 2024, the entire contents of which are incorporated herein by reference.

### FIELD

Embodiments of the present invention relate generally to an information processing apparatus and a feature amount inference method.

### BACKGROUND

When a prompt in a natural language is input and an output such as a sentence or an image is generated in a generation model, an output that meets the demand of the user is not necessarily obtained. In order to obtain a generation result desired by the user, so-called prompt engineering skills are required, such as adjusting a prompt until a desired result is obtained, or searching for a prompt and an output result of another user, which deteriorates convenience of the user. Therefore, it is required to provide an information processing apparatus capable of inferring a personalized feature amount on the basis of an attribute of a user and a feature amount input by the user.

### BRIEF DESCRIPTION OF THE DRAWINGS

FIG. 1 is a schematic diagram illustrating an example of a configuration of an information processing system.

FIG. 2 is an example of a flowchart illustrating processing of an information processing apparatus.

FIG. 3 is an example of a flowchart illustrating processing related to user information acquisition in step S4.

FIG. 4 is an example of a format for inputting attribute information of a user.

FIG. 5 is an example of a flowchart illustrating interface processing in step S5.

FIG. 6 is an example of an image generation interface.

FIG. 7 is an example of a flowchart illustrating image generation processing in step S6.

FIG. 8 is an example of a schematic diagram of a personalized feature amount model.

FIG. 9 is an example of a flowchart illustrating processing of an information processing apparatus in a first modification.

FIG. 10 is an example of a schematic diagram of an information processing system according to a second embodiment.

FIG. 11 is an example of a flowchart illustrating processing of the information processing apparatus according to the second embodiment.

FIG. 12 is an example of a schematic diagram of an information processing system according to a third embodiment.

FIG. 13 is an example of a flowchart illustrating processing in step S6 in the third embodiment.

FIG. 14 is an example of an image generation interface according to a seventh embodiment.

FIG. 15 is an example of an image generation interface according to an eighth embodiment.

### DETAILED DESCRIPTION

An information processing apparatus according to an embodiment includes a personalized feature amount inference unit configured to infer a second prompt token sequence related to a second feature amount on the basis of data related to background information of a person having an attribute close to an attribute of a first user, among data included in a background information database accumulating background information in which attribute information related to an attribute of a person, a feature amount input by the person, and a behavior history related to an action of the person with respect to a product generated on the basis of the feature amount are associated with each other, and a first feature amount input by the first user.

Hereinafter, embodiments will be described with reference to the accompanying drawings. In each embodiment, substantially the same components are denoted by the same reference numerals, and the description thereof may be partially omitted. The drawings are schematic, and the relationship between the thickness and the planar dimensions of each part, the ratio of the thicknesses of each part, and the like may be different from actual ones.

In the present specification, making a state that is assumed to be suitable for an individual user will be described as “personalize”. In addition, in the present specification, it is assumed that the “feature amount” is an element capable of describing the feature of the product, and the product is generated by inputting the “feature amount” as a prompt to the generation model.

### First Embodiment

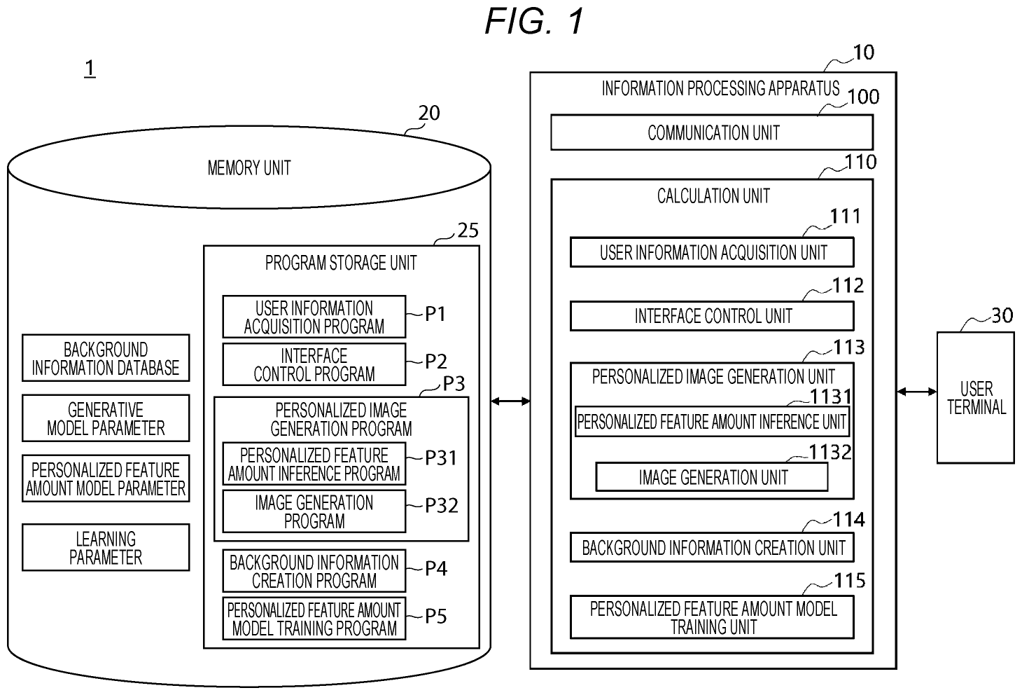

FIG. 1 is a schematic diagram illustrating an example of a configuration of an information processing system 1 according to the present embodiment. The information processing system 1 includes an information processing apparatus 10, a storage unit 20, and a user terminal 30. The information processing apparatus 10, the storage unit 20, and the user terminal 30 are communicatively connected to each other via a network. As the network, various communication networks such as the Internet can be adopted regardless of whether the network is wired or wireless.

The information processing apparatus 10 can be realized by a hardware terminal such as a computer.

The information processing apparatus 10 outputs a feature amount suitable for obtaining a product estimated to be desired by a user on the basis of a feature amount input by the user and information regarding the user stored in the storage unit 20. The information processing apparatus 10 includes a communication unit 100 and a calculation unit 110.

The communication unit 100 is realized by, for example, a network interface card (NIC) or the like. The information processing apparatus 10 is connected to the storage unit 20 and the user terminal 30 in a wired or wireless manner, and transmits and receives information via the communication unit 100. There are various types of information exchanged in the present embodiment, such as user attributes and personal information, a program loaded from the storage unit 20 and executed by the information processing apparatus 10, and a result output by the information processing apparatus 10.

The calculation unit 110 is a processing unit that controls the entire information processing apparatus 10, and is, for example, a central processing unit (CPU), a micro processing unit (MPU), or the like (so-called processor). The calculation unit 110 deploys various programs (for example, a user information acquisition program P1 illustrated in the present embodiment) stored in the storage unit 20 in a random access memory (RAM) serving as a work area and executes the programs. Furthermore, the calculation unit 110 is realized by, for example, an integrated circuit such as an application specific integrated circuit (ASIC) or a field programmable gate array (FPGA). The calculation unit 110 includes: a user information acquisition unit 111 that acquires attribute information of a user by loading and executing a user information acquisition program P1; an interface control unit 112 that controls an interface to be displayed on a display unit of the user terminal 30 by loading and executing an interface control program P2; a personalized image generation unit 113 that generates an image that the user is likely to like from an input feature amount and outputs a generated image by loading and executing a personalized image generation program P3; a background information creation unit 114 that stores the attribute information of the user and a behavior history in association with each other in a storage unit 20 by loading and executing a background information creation program P4; and a personalized feature amount model training unit 115 that trains, based on the attribute information of the user, a personalized feature amount model for inferring a feature amount that makes it easy for the user to obtain a desired generation result by loading and executing a personalized feature amount model training program P5.

Note that the internal configuration of the information processing apparatus 10 is not limited to the illustrated configuration, and may be another configuration as long as the configuration can execute processing of inferring the feature amount (second feature amount) that makes it easy for the user to obtain a desired generation result on the basis of the feature amount (first feature amount) input by the user and the attribute information of the user. Furthermore, the connection relationship of the processing units included in the calculation unit 110 is not limited to the illustrated connection relationship, and may be another connection relationship.

The storage unit 20 is realized by, for example, a semiconductor memory element such as a RAM or a flash memory, or a storage device such as a hard disk or an optical disc.

The storage unit 20 includes a program storage unit 25 that is an area for storing a program that can be loaded and executed by the calculation unit 110 included in the information processing apparatus 10, in addition to an area in which a generation model parameter, a personalized feature amount model parameter, a background information database, a learning parameter, and the like to be described below can be stored. The storage unit 20 may be provided inside the information processing apparatus 10 or may be an on-premises server. Furthermore, the storage unit 20 may be provided in the form of a cloud server or the like that stores data via a cloud. The information stored in the storage unit 20 is loaded by the calculation unit 110 included in the information processing apparatus 10.

Hereinafter, the information stored in the storage unit 20 and the program storage unit 25 will be described in order.

The background information database is a database that accumulates background information in which attribute information related to an attribute of a person, a feature amount input by the person, and a behavior history related to an action of the person with respect to a product generated on the basis of the feature amount are associated with each other. This person may be a user who has used the information processing system 1 in the past, or may be a person whose attribute information, input feature amount, and the behavior history are known even if the information processing system 1 itself has not been used. The background information database includes data related to the attribute information of the user acquired by the calculation unit 110 loading and executing the user information acquisition program P1, and data created by the calculation unit 110 loading and executing the background information creation program P4. The storage unit 20 stores attribute information of the user who uses the present system in association with an action (behavior history) of the user with respect to the present system. These background information databases are not necessarily stored in the storage unit 20 from the beginning of the operation of the information processing apparatus 10, and may be created and updated each time the attributes information and the behavior history of the user are added.

The generation model parameters are parameters related to the weight of the deep learning model and other parameters in the generation model that outputs the generation data from the token sequence assigned to the feature amount input as the prompt. In the present embodiment, a description will be given on the assumption that the input feature amount takes a form of a prompt (natural language) and the token sequence is a sequence of codes (tokens) representing morphemes of the prompt. As a modality of the generation data, various objects such as an image, text, and audio are conceivable, but in the present embodiment, a case where the generation data is an image will be described as an example. Note that, when the token is input to the deep learning model, the token is converted into a vector and processed in general input preprocessing, but since the vector is simply different expression forms having the same content, the vector is not distinguished from the token in this description. As a method of converting a token as a code into a vector, a known method such as one-hot encoding or embedding in a distributed representation can be considered.

The personalized feature amount model parameter is a generic term of a parameter related to the weight of the deep learning model and other parameters in the personalized feature amount inference model for the purpose of inferring the second prompt token sequence related to the second feature amount for the user from the attribute information token sequence related to the attribute information of the user and the first prompt token sequence related to the first feature amount. In the present embodiment, the second feature amount will be described as a prompt corresponding to a token sequence (hereinafter, referred to as a “second prompt token sequence”) suitable for generation of generation data (generated image) estimated to be desired by the user. The personalized feature amount model parameter is created or updated by executing the personalized feature amount model training program P5 based on the background information database regarding the user stored in the storage unit 20. The personalized feature amount model parameter does not need to be stored in the storage unit 20 from the beginning of the operation start of the information processing apparatus 10, and may be added and updated as appropriate each time the background information of the user is added.

The learning parameter is a parameter used for training of the deep learning model in the personalized feature amount model training program P5. The parameters used for training of the deep learning model mainly include a batch size, the number of epochs, a learning rate, and the like.

The program storage unit 25 stores various programs loaded and executed by the calculation unit 110, such as a user information acquisition program P1, an interface control program P2, a personalized image generation program P3, a background information creation program P4, a personalized feature amount model training program P5, a personalized feature amount inference program P31, and an image generation program P32.

The user terminal 30 is, for example, a personal computer, a smartphone, a tablet terminal, or the like. The user terminals 30 can communicate with each other via a network, and can access a result output from the information processing apparatus 10 via the Internet or the like.

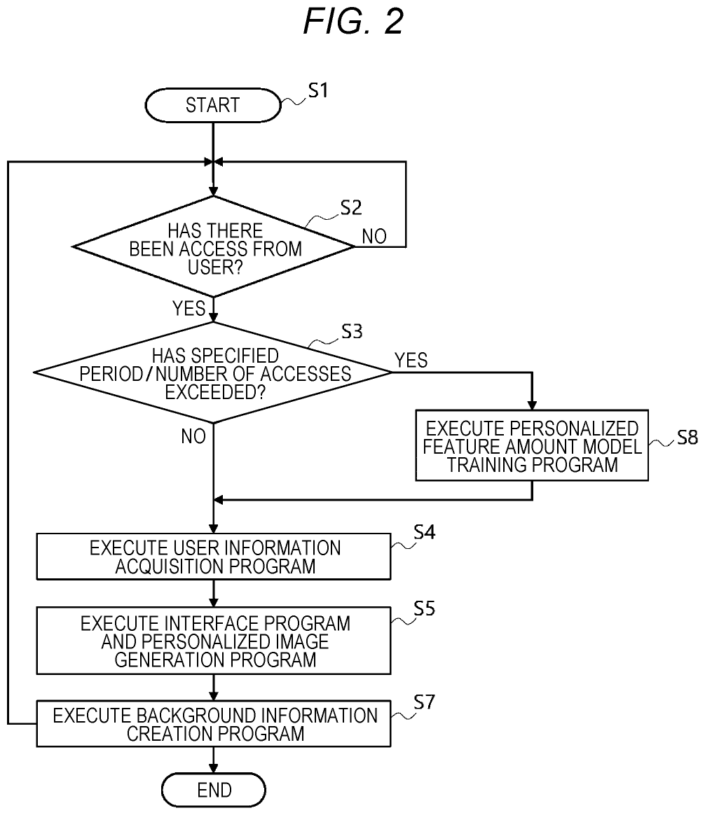

FIG. 2 is an example of a flowchart illustrating processing of the information processing apparatus 10 in the present embodiment. In the present specification, first, a basic series of flow of generating an image using a first prompt token sequence related to a first feature amount input by a user as an input will be described, and then a flow including a training step S8 of a personalized feature amount model and an inference step S65 of a second prompt token sequence using the personalized feature amount model will be described.

After information processing by the information processing system 1 is started in the first step S1, in step S2, the information processing 0 determines whether or not the user has accessed the information processing system 1. The information processing apparatus 10 can acquire a history of access to the information processing system 1 by the user using the user terminal 30 via the communication unit 100. If the user has accessed the information processing system 1, the process proceeds to the next step S3. If the user has not accessed the information processing system 1, the determination in step S2 is repeated until the user's access is confirmed.

In step S3, the information processing apparatus 10 determines whether or not the access history of the user has achieved a predetermined condition. The predetermined condition is, for example, whether or not a predetermined period sufficient for accumulating a certain number or more of pieces of information has elapsed since the information processing apparatus 10 started information processing, whether or not there has been access by a certain number or more of users, or the like. When it is determined that the access history of the user has not achieved the predetermined condition, the process proceeds to the next step S4. A flow in a case where it is determined that the access history of the user has achieved the predetermined condition will be separately described below.

In step S4, the user information acquisition unit 111 executes the user information acquisition program P1 and acquires the attribute information of the user input to the user terminal 30.

In step S5, the interface control unit 112 executes the interface control program P2 to display an image generation interface for image generation on the display unit of the user terminal 30. When the user inputs a prompt for image generation to the image generation interface, the personalized image generation unit 113 executes the personalized image generation program P3, and an image is generated based on the prompt. The user can confirm the generated image by displaying the generated image on the image generation interface by the interface control unit 112. The interface control unit 112 can appropriately update the image generation interface in response to a prompt input by the user or in order to display the generated image.

In step S7, the background information creation unit 114 executes the background information creation program P4, associates the attribute information of the user with the behavior history regarding the prompt input in step S5, and stores the associated information in the storage unit 20. The process proceeds to step S2. Alternatively, the information processing by the information processing system 1 may be ended after step S7 upon receiving some signal related to the end.

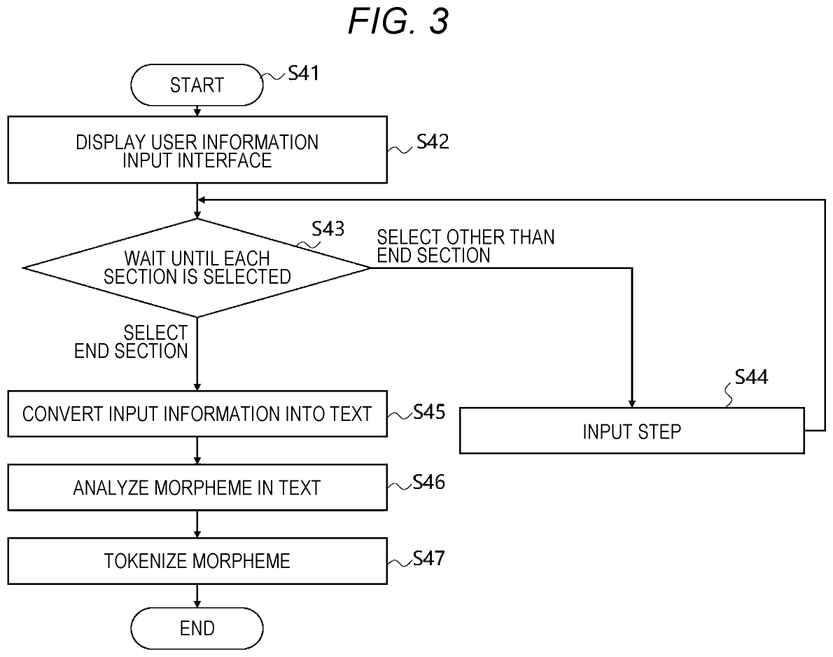

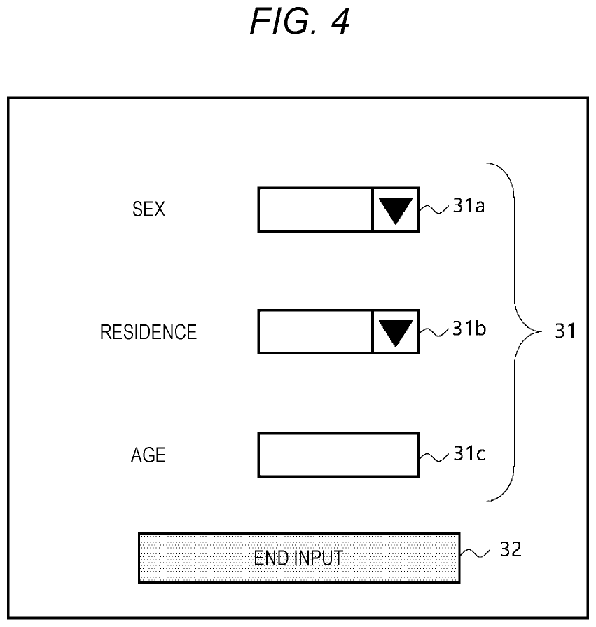

FIG. 3 is an example of a flowchart illustrating processing related to user information acquisition in step S4. When the user information acquisition unit 111 starts loading and executing the user information acquisition program P1 in step S41, the user information acquisition unit 111 outputs an instruction to display a format for inputting the attribute information of the user on the user terminal 30 in step S42. The attribute information of the user of the present embodiment includes personal information that determines the attribute of the user, such as the sex, residence, and age of the user. However, the attribute information of the user is not limited thereto, and other types of parameters useful for generating a product more matching the user's preference may be used as the attribute information. FIG. 4 is an example of a format for inputting attribute information of a user. This format includes an input section 31 (the generic term for sections 31a to 31c is the input section 31) that inputs one or a plurality of pieces of different information related to the attribute information of the user, and an end section 32 that selects when ending the input. FIG. 4 illustrates a case where the format includes an input section 31a that can select the sex from the pull-down as the personal information of the user, an input section 31b that can select the domicile (country, region, prefecture, municipality, and the like) from the pull-down, and an input section 31c that can input the age, and a button that can end the step of inputting the attribute information by being selected by the user after inputting the attribute information is displayed as the end section 32.

In step S43, the user information acquisition unit 111 waits until the user selects the input section 31 or the end section 32. When the input section 31 is selected, the process proceeds to step S44, and the user information acquisition unit 111 acquires the attribute information of the user input in the user terminal 30 via the communication unit 100 and writes the attribute information in the storage unit 20.

When the end section 32 is selected in step S43, the process proceeds to step S45, and the user information acquisition unit 111 loads and executes the user information acquisition program P1 and converts the input attribute information of the user into text. The user information acquisition unit 111 creates a fixed phrase from the input attribute information. For example, when “woman” as the sex, “Shizuoka prefecture” as the residence, and “38-year-old” as the age are input in the format, the user information acquisition unit 111 creates a fixed phrase “38-year-old woman resident in Shizuoka prefecture”.

In step S46, user information acquisition unit 111 loads and executes user information acquisition program P1, and decomposes the created fixed phrase into small units. For example, the created fixed phrase is decomposed into morphemes such as “thirty/eight/year-old/woman/resident/Shizuoka/prefecture”. As a means for decomposing the created fixed phrase into morphemes, an existing morpheme analysis engine can be used, and for example, existing software such as MeCab or Janome can be used. Note that step S46 can be omitted depending on the language used by the user. For example, in the case of a language, such as English, French, or German, in which words are separated by a space, a code such as a space, a comma, a period, or a colon in a sentence can be used to determine a dividing method into morphemes. Note that, in order to perform more accurate morpheme analysis for a language such as English, a model represented by natural language toolkit (NLTK) may be used.

In step S47, a token that is a code representing the morpheme is allocated. A sequence of tokens obtained in this manner is hereinafter referred to as an attribute information token sequence. The user information acquisition unit 111 outputs the attribute information token sequence, stores the attribute information token sequence in the storage unit 20, and ends the user information acquisition program P1.

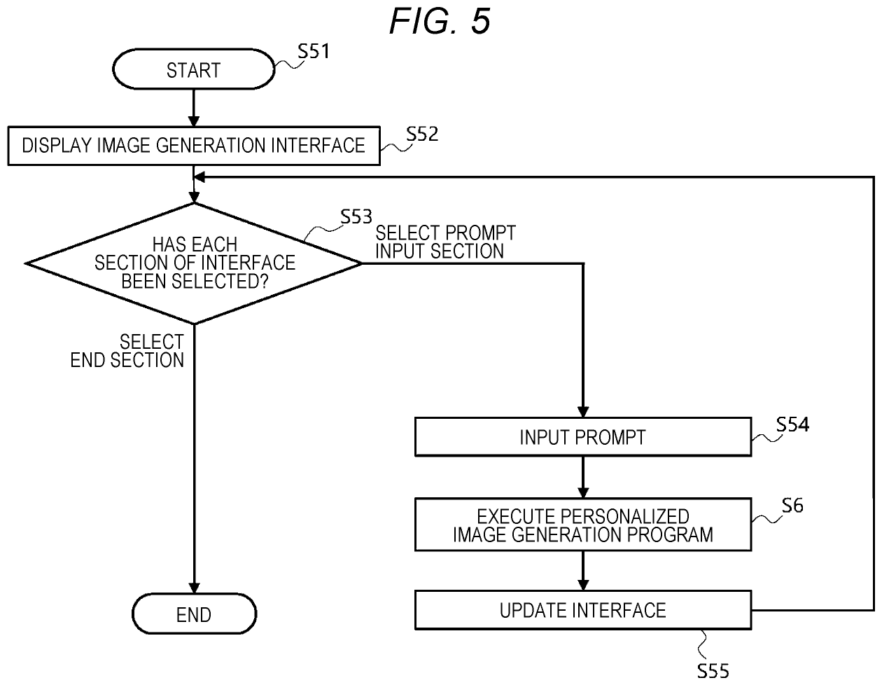

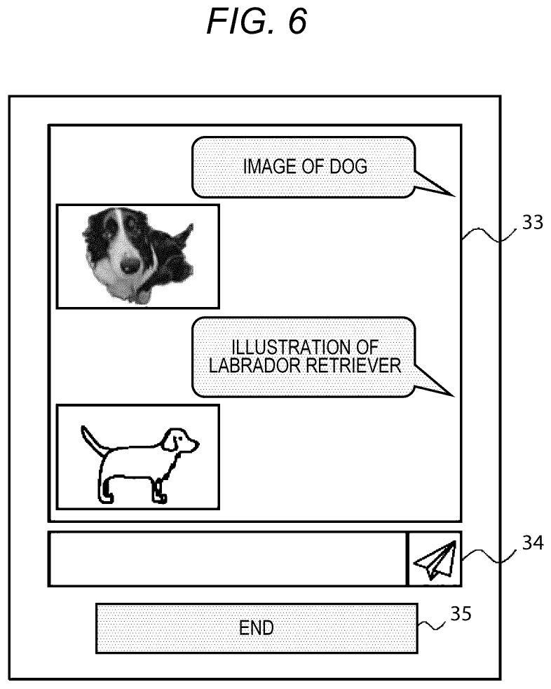

FIG. 5 is an example of a flowchart illustrating the interface processing in step S5. When the interface control unit 112 starts loading and executing the interface control program P2 in step S51, the interface control unit 112 outputs an instruction to display the image generation interface on the display unit of the user terminal 30 in step S52. FIG. 6 is an example of an image generation interface. The image generation interface includes a history display section 33, a prompt input section 34, and an end section 35. When the interface in the figure is displayed on the display unit of the user terminal 30, the user can enter text as a prompt in the prompt input section 34 or select the end section 35. The prompt input to the prompt input section 34 and transmitted to the information processing system 1 is displayed on the history display section 33 as a transmitted prompt. Further, the image generation interface is updated so that the image generated in the form that follows the transmitted prompt is displayed on the history display section 33. The user can end the steps of the interface processing by selecting a button displayed as the end section 35.

In step S53, the user can make an input to the prompt input section 34 or select the end section 35. The interface control unit 112 waits until the user selects the prompt input section 34 or the end section 35. When the prompt input section 34 is selected, the process proceeds to step S54, and the interface control unit 112 acquires the prompt input in the user terminal 30 via the communication unit 100.

In step S6, the personalized image generation unit 113 loads and executes the personalized image generation program P3, generates an image from the input prompt, outputs the generated image, and ends step S6. Detailed process in step S6 will be described below.

In step S55, the interface control unit 112 loads and executes the interface control program P2, and updates the interface displayed on the user terminal 30 so as to display the image generated in step S6 on the history display section 33. Upon completion of step S55, the process proceeds to step S53 again.

In step S53, the user can make an input to the prompt input section 34 or select the end section 35. If the user is satisfied with the output image in step S6, the user is considered to select the end section 35, but if the user wishes to correct the output image, for example, if the output image is different from what the user intended, the user may select the prompt input section 34 and proceed to step S54 again to input a prompt. Subsequently, in step S6, the personalized image generation unit 113 generates and outputs an image in consideration of a newly input prompt, and in step S55, the interface control unit 112 updates the interface so as to display the newly generated image on the history display section 33. The user can repeat the input of the prompt and the confirmation of the generated image (steps S53 to S55) until the user is satisfied with the generated image. In a case where the interface displayed on the user terminal 30 is updated so as to display a new generated image on the history display section 33, as illustrated in FIG. 6, a previous prompt and a generated image based on the prompt may be left as a history, or only a new generated image may be displayed.

When the end section 35 is selected in step S53, the interface control unit 112 terminates the interface control program P2.

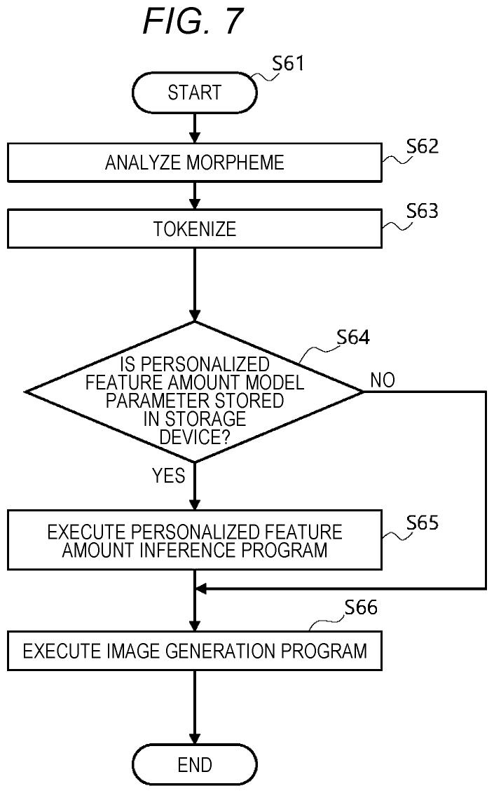

FIG. 7 is an example of a flowchart illustrating image generation processing in step S6. When the personalized image generation unit 113 starts loading and executing the personalized image generation program P3 in step S61, a personalized feature amount inference unit 1131 decomposes the created fixed phrase into small units in step S62. For example, when a prompt “image of dog” is input as the first feature amount to the prompt input section 34, the prompt is decomposed into morphemes such as “image/of/dog” and morphologically analyzed. As a means for decomposing into morphemes, an existing morpheme analysis model can be used, and for example, existing software such as MeCab or Janome may be used.

In step S63, the personalized feature amount inference unit 1131 allocates a token to each morpheme. This sequence of tokens is referred to as a first prompt token sequence.

In step S64, the personalized feature amount inference unit 1131 determines whether or not the personalized feature amount model parameter is stored in the storage unit 20. Here, a case where the personalized feature amount model parameter is not stored will be described first. When it is determined that the personalized feature amount model parameter is not stored, the process proceeds to step S66.

In step S66, an image generation unit 1132 loads and executes the image generation program P32, and generates an image using the first prompt token sequence as an input. First, the image generation unit 1132 loads the generation model parameters stored in the storage unit 20. The generation model parameter is a parameter included in a generation model that generates an image from the first prompt token sequence, and an existing generation model can be used as such a generation model. For example, a diffusion model combined with a Transformer model can be used as the generation model. Subsequently, the image generation unit 1132 generates an image from the first prompt token sequence on the basis of the generation model. The generated image is output, and step S6 is ended. When the end section 35 is selected at the end of step S6, the process proceeds to step S7.

The processing of step S6 described above is similarly performed in a case where the second and subsequent prompts are input by the user. For example, in a case where the user is not satisfied with the generated image output on the basis of the prompt “image of dog”, and additionally inputs the prompt “illustration of Labrador Retriever”, the personalized image generation unit 113 executes steps S61 to S66, thereby outputting a new generated image from the prompt token sequence “illustration/of/Labrador Retriever”.

In subsequent step S7, the background information creation unit 114 loads and executes the background information creation program P4, associates the attribute information of the user with the behavior history regarding the input prompt, and stores the associated information in the storage unit 20 as the background information of the user. Here, the behavior history is what prompt the user has further added after inputting the prompt, and whether or not the user has selected the end section 35 after the generated image is displayed. That is, the behavior history refers to an action on the product of the user, and it is considered that this action can indicate the satisfaction level of the product of the user and the thought pattern and the action pattern until the user approaches the desired product. At this time, the content and the context of the prompt written in the storage unit 20 or the time data at which the prompt is input are used together as the behavior history.

The above is a description of a basic series of flows for generating an image using the first prompt token sequence related to the first feature amount input by the user as an input. A flow including the training step S8 of the personalized feature amount model and the inference step S65 of the second prompt token sequence using the personalized feature amount model will be described below.

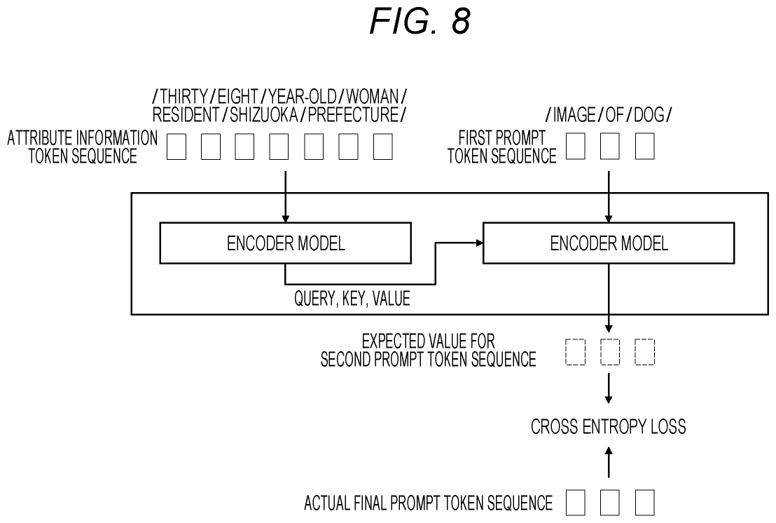

A flow in a case where it is determined in step S3 that the access history of the user has achieved the predetermined condition will be described. The state in which the predetermined condition is achieved is, for example, a state in which a predetermined period or more has elapsed since the information processing apparatus 10 started information processing, or a state in which a certain number or more of users have accessed. At this time, it is determined that data sufficient for training the personalized feature amount model has been accumulated, and the personalized feature amount model training program P5 is executed in step S8. The personalized feature amount model training unit 115 can cause the personalized feature amount model to be trained by executing the personalized feature amount model training program P5. FIG. 8 is an example of a schematic diagram of a personalized feature amount model, in which the personalized feature amount model can be trained based on background information in which attribute information of a user, a first feature amount input by the user, and a behavior history of the user with respect to a product generated based on the first feature amount or the second feature amount are associated with each other. In the drawing, a case where the Transformer model is used as the personalized feature amount model will be exemplified.

The personalized feature amount model can be trained by inferring the second prompt token sequence in which the second feature amount is tokenized based on the attribute information token sequence in which the attribute information of the user is tokenized and the first prompt token sequence in which the first feature amount input by the user is tokenized, calculating the cross entropy loss related to the second prompt token sequence, and updating the personalized feature amount model using the error back propagation.

Specifically, first, the personalized feature amount model training unit 115 initializes the personalized feature amount model parameter. Examples of the initialization method include zero filling for substituting zero for a parameter, random weighting for substituting a random number for a parameter, and loading of a previously trained personalized feature amount model parameter. Subsequently, the first feature amount and the final feature amount input immediately before the user selects the end section 35 are extracted from the background information database stored in the storage unit 20, and morpheme analysis and token allocation are performed to obtain a first prompt token sequence and a final prompt token sequence, respectively. The attribute information token sequence associated with the behavior history of the user is input to the encoder model of the personalized feature amount model, and the first prompt token sequence is input to the decoder model of the personalized feature amount model together with the query, the key, and the value output from the encoder model, so that the inference related to the second prompt token sequence is executed. Training is performed such that the inference result is close to the final prompt token sequence related to the final feature amount actually input by the user. As an example of this training, a method of calculating the cross entropy loss between the output vector representing the likelihood of each token sequence included in the second prompt token sequence output as the inference result and the final prompt token sequence, and updating the personalized feature amount model parameter by the error backpropagation method can be considered. Note that the processing for updating the personalized feature amount model parameter is not limited to the above processing. For example, the likelihood of the inference result related to the final prompt token sequence may be obtained by inputting the first prompt token sequence to the encoder model and inputting the attribute information token sequence to the decoder model together with the query, the key, and the value output from the encoder model, or the likelihood of the inference result related to the final prompt token sequence may be obtained by including a plurality of encoder models in the personalized feature parameter, inputting the first prompt token sequence to one encoder model (first encoder model) among the plurality of encoder models, inputting the attribute information token sequence to another encoder model (second encoder model), and inputting data related only to basic information indicating the start of the token sequence together with the query, the key, and the value output from the first and second encoder models to the decoder model. The personalized feature amount model training unit 115 stores the updated personalized feature amount model and parameter in the storage unit 20, and ends step S8.

Step S4 performed after step S8 is completed is as described above.

In the processing in step S6 included in step S5 performed subsequently, in step S64, the personalized image generation unit 113 determines that the personalized feature amount model parameters are stored in the storage unit 20. In this case, the process proceeds to step S65 after step S64.

In step S65, the personalized feature amount inference unit 1131 loads and executes the personalized feature amount inference program P31 to infer the second prompt token sequence related to the second feature amount based on the data related to the background information of the person having the attribute close to the attribute of the user who uses the information processing system 1 among the data included in the background information database and the first feature amount input by the user. Here, in the deep learning model, the attribute information which contributes to the difference between the first and second prompt token sequences is extracted in a key, value, and query format. When the extracted attribute information are close to each other, it is assumed that a returned combinations of key, query, and value for the second prompt token sequence is close to those for the input first prompt token sequence. The similarity between two prompt token sequence from the perspective of the key, the value, and the query can be defined by known calculation of similarity using mutual attention. Except for the case that there is second feature amount which frequently becomes an outlier in a specific age and residential area, it is expected from general machine learning knowledge that two attribute information with minor differences, such as age or residential area, are learned to be close to each other.

In addition, among the second feature amounts, a feature amount with high likelihood for a product estimated to be desired by the user is set as the personalized feature amount. First, the personalized feature amount inference unit 1131 loads the personalized feature amount model from the storage unit 20. Here, a case where the personalized feature amount model is a model trained on the basis of a database including a past behavior history that a person having attribute information “38-year-old woman resident in Shizuoka prefecture” inputs a first feature amount “image of dog”, confirms a generated image for the first feature amount, further inputs a final feature amount “illustration of Labrador Retriever”, and selects the end section 35 after confirming the generated image for the final feature amount will be described as an example. The personalized feature amount inference unit 1131 uses the personalized feature amount model to infer the personalized prompt token sequence by selecting the token sequence on the basis of the likelihood sequence of the second prompt token sequence output from the attribute information token sequence in which the attribute information of the user is tokenized and the first prompt token sequence in which the first feature amount is tokenized. As an example, a method of selecting a token having the maximum likelihood corresponding to each position of the token sequence can be considered, but the method is not limited thereto. Here, the personalized prompt token sequence is obtained by tokenizing the personalized feature amount. As a specific example, it is assumed that a user of the current information processing system 1 inputs “41-year-old female resident in Yamanashi Prefecture” as attribute information, and inputs a first feature amount of “image of dog”. There is a high possibility that the personalized feature amount inference unit 1131 outputs a personalized prompt token sequence “illustration/of/Labrador Retriever” from the attribute information token sequence “forty/one/year-old/female/resident/Yamanashi/prefecture” and the first prompt token sequence “image/of/dog” using the personalized feature amount model that has already completed training using background information of “38-year-old female resident in Shizuoka prefecture” having an attribute close to the current user. After outputting the thus inferred personalized prompt token sequence, the personalized feature amount inference unit 1131 terminates the personalized feature amount inference program P31 and proceeds to step S66.

In step S66, the image generation unit 1132 loads and executes the image generation program P32, and generates an image with the second feature amount as an input prompt. After outputting the generated image, the image generation unit 1132 ends the image generation program P32 and ends step S6.

The processing in subsequent step S7 is as described above.

There is a high possibility that users having close attributes prefer the same image because cultures shared by the users are similar in age, region, and the like. Therefore, as described above, by executing the image generation program with the personalized prompt token sequence inferred using the personalized feature amount model as an input, it is easy to generate an image that will be desired by the user having a close attribute. As a result, the user can obtain a desired image with a high possibility without taking the trouble of trial and error of the feature amount input as the prompt.

Note that, in the above embodiment, the case where the first feature amount and the second feature amount are natural languages has been described as an example, but the modality of the first feature amount and the second feature amount are not limited thereto. For example, the first feature amount may be an image, and a natural language or an image may be output as the second feature amount by putting the first feature amount into, for example, a trained vision transformer model. In particular, in the case of an image, tokenization by morpheme analysis in the above embodiment is replaced with tokenization by known patch processing or the like.

### First Modification

In the first embodiment, after it is determined in step S2 that there is an access from the user, it is determined in step S3 whether or not the access history has achieved a predetermined condition. In a case where it is determined that the condition has been achieved, the processing proceeds to step S8, and the personalized feature amount model parameter is trained in the personalized feature amount model training unit 115. However, the timing at which the personalized feature amount model parameter is trained is not limited to the order illustrated in the first embodiment. In the present embodiment, the timing at which the training of the personalized feature amount model parameter other than that illustrated in the first embodiment is performed is exemplified.

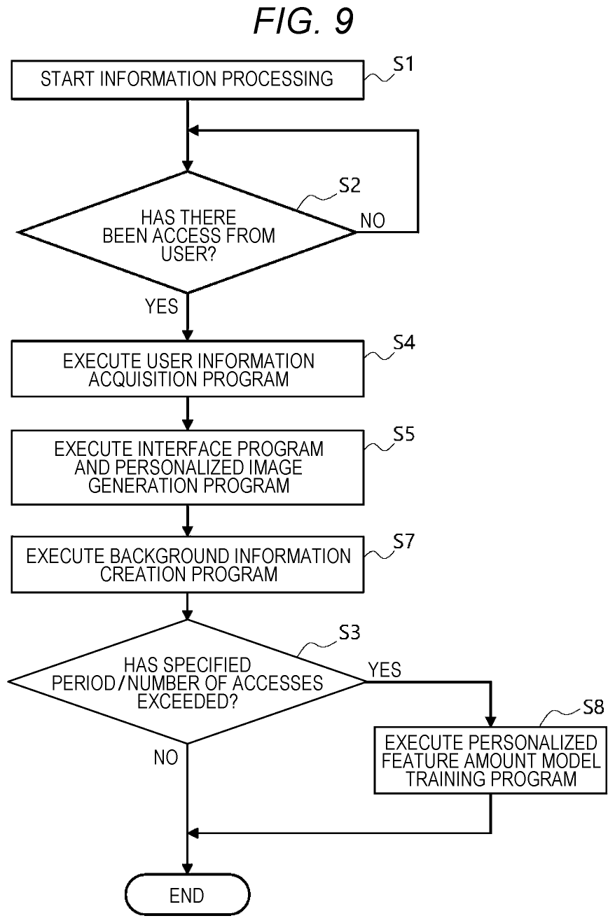

FIG. 9 is an example of a flowchart illustrating processing of the information processing apparatus 10 in the present modification. In the present modification, after it is determined in step S2 that there is an access from the user, step S4, step S5, and step S7 are executed, and then the determination regarding the access history in step S3 is performed. By setting the processing order of the information processing apparatus 10 as illustrated in the present modification, it is not necessary to wait for training of the personalized feature amount model until obtaining the product in step S5 after the user accesses the information processing system 1, and the convenience of the user is improved.

Note that the processing illustrated in the present modification is an example, and the timing at which step S3 and step S8 are executed is not limited to this example. For example, step S8 may be executed when it is determined in step S2 that there is no access from the user, or training of the personalized feature amount model may be executed by another CPU and may not appear in these flowcharts.

### Second Modification

In the first embodiment, the deep learning model is used, but in the rule-based method not using the deep learning, a method is also conceivable in which the closeness of the attribute information is calculated by comparing the parameter indicating the attribute related to the person included in the background information database with the same type of parameter indicating the attribute related to the current user, the behavior history of a group of users having close attribute information is extracted from the background information database, and morphemes co-occurring with the morphemes included in the first feature amount input by the current user are supplemented. As a definition of the closeness, for example, in a case where age is included in the parameter indicating the attribute, it is conceivable to set a user having attribute information from a person included in the background information database to three years old before and after the current user's age as a “user with close attribute” and perform the above processing. In this example, the threshold for how many years before and after are determined as “attributes are close” is stored in the storage unit 20 as one of the personalized feature amount model parameters, and may be adjusted in accordance with training of the personalized feature amount model, or an arbitrary range may be designated by the user. As a result, similarly to the above embodiment, it is possible to obtain an effect that the second prompt token sequence having a close value is output to the user having close attribute information with respect to the input of the same first prompt token sequence.

### Second Embodiment

In the present embodiment, an embodiment common to the first embodiment will be omitted, and only portions different from the first embodiment will be described. In addition, the same names and reference numerals as those of the first embodiment will be used for description.

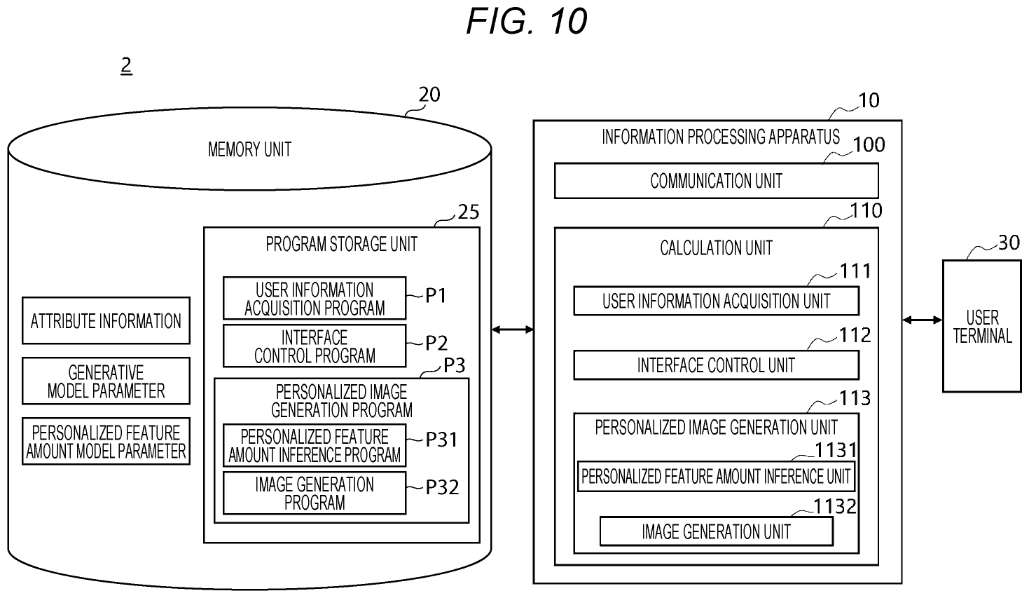

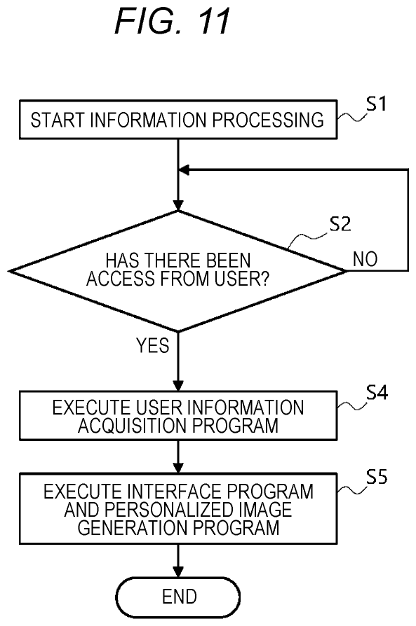

FIG. 10 is an example of a schematic diagram of the information processing system 2 according to the present embodiment. Unlike the first embodiment, in the information processing system 2, the storage unit 20 only needs to store the attribute information of the user who is using the information processing system 1 in a short term during the system operation, and does not need to store data associating the attribute information of the past user with the behavior history as the background information database in a long term. In addition, the storage unit 20 does not need to store the learning parameter. Furthermore, the program storage unit 25 does not need to store the background information creation program P4 and the personalized feature amount model training program P5. Further, the calculation unit 110 may not include the background information creation unit 114 and the personalized feature amount model training unit 115. FIG. 11 is an example of a flowchart illustrating processing of the information processing apparatus 10 in the present embodiment. In comparison with the processing illustrated in FIG. 2, the processing in the present embodiment does not include step S3 of determining whether or not the access history of the user has achieved the predetermined condition, step S7 of storing the attribute information of the user and the behavior history in association with each other, and step S8 of executing the personalized feature amount model training program P5. In the present embodiment, instead of executing the personalized feature amount model training program P5 in the information processing system and constructing the personalized feature amount model, the personalized feature amount model already constructed outside the information processing system 2 is acquired via the communication unit 100 and used when generating the personalized image. Alternatively, a result of preliminary learning using a large-scale data set may be stored in the storage unit 20 in advance.

In this manner, the use capacity of the storage unit 20 can be reduced by using the personalized feature amount model constructed outside the information processing system 2 for the construction. Furthermore, since the processing flow can be simplified, hardware having small machine resources can be used as the information processing apparatus 10.

### Third Embodiment

In the present embodiment, an embodiment common to the first and second embodiments will be omitted, and only portions different from the first and second embodiment will be described. In addition, the same names and reference numerals as those of the first and second embodiments will be used for description.

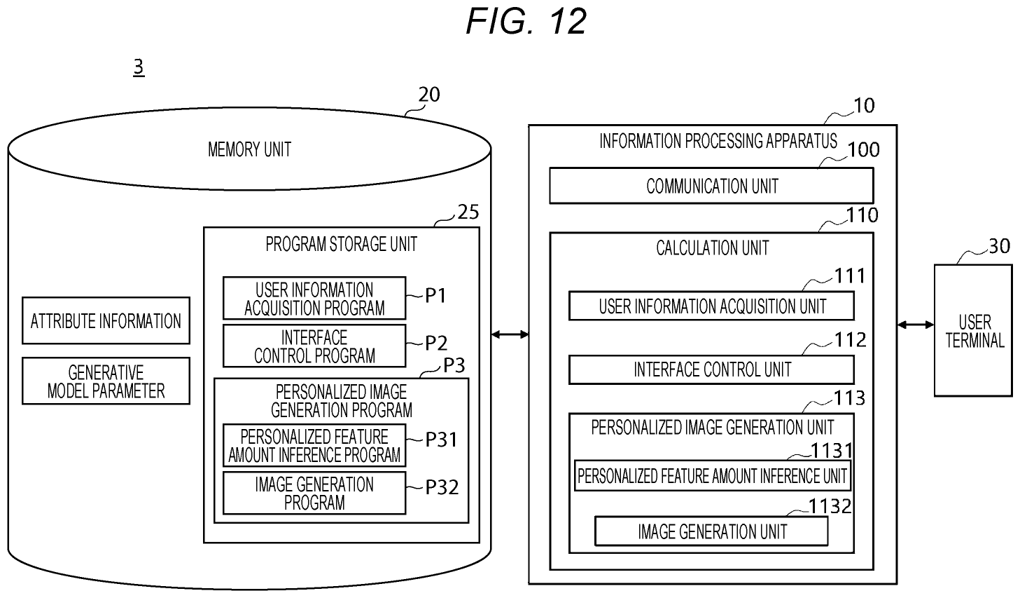

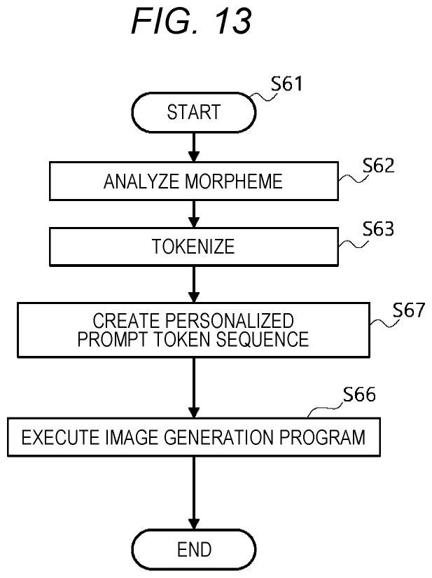

FIG. 12 is an example of a schematic diagram of the information processing system 3 according to the present embodiment. In the present embodiment, the personalized feature amount inference unit 1131 adds the attribute information of the user to the first feature amount input by the user to infer the second prompt. Unlike the first embodiment, in the information processing system 3, the storage unit 20 only needs to store the attribute information of the user who is using the information processing system 1 in a short term during the system operation, and does not need to store data associating the attribute information of the past user with the behavior history as the background information database in a long term. In addition, the storage unit 20 does not need to store the personalized feature amount model parameter and the learning parameter. Furthermore, the program storage unit 25 does not need to store the background information creation program P4 and the personalized feature amount model training program P5. Further, the calculation unit 110 may not include the background information creation unit 114 and the personalized feature amount model training unit 115. The processing of the information processing apparatus 10 in the present embodiment is the same as the processing in the second embodiment illustrated in FIG. 11. However, a part of the detailed processing in step S6 is different. FIG. 13 is an example of a flowchart illustrating processing in step S6 in the present embodiment. In comparison with the processing illustrated in FIG. 7, the processing in the present embodiment does not include step S64 of determining whether or not the personalized feature amount model parameter is stored in the storage unit 20. In the present embodiment, when loading and executing the personalized feature amount inference program P31, the personalized feature amount inference unit 1131 executes step S67 of creating the second prompt token sequence according to a predetermined rule that does not require training from the attribute information token sequence and the first prompt token sequence, instead of using the personalized feature amount model. The second prompt token sequence created according to a predetermined rule that does not require training is, for example, an attribute information token sequence and an input prompt token sequence connected by a simple fixed token sequence. Specifically, in a case where the attribute information of the user related to the attribute information token sequence is “38-year-old woman resident in Shizuoka prefecture” and the first feature amount is “image of dog”, the token sequence related to “an image of a dog preferred by a 38 year-old female resident in Shizuoka Prefecture” is output as the second prompt token sequence.

As described above, by using the second prompt token sequence created according to a predetermined rule that does not require training, preliminary learning of a huge model and parameters thereof is not necessary. Therefore, the second embodiment can be moved on hardware having smaller machine resources than the second embodiment, and can be executed even in a case where time for preliminary learning cannot be taken.

### Fourth Embodiment

In the present embodiment, an embodiment common to the first to third embodiments will be omitted, and only portions different from the first to third embodiment will be described. In addition, the same names and reference numerals as those of the first to third embodiments will be used for description.

In the present embodiment, instead of prompting the user to input the attribute information of the user by operating the interface in step S4, the user information acquisition unit 111 acquires the identifier from the user terminal 30, and inquires of an external server holding information related to the identifier to acquire the attribute information of the user. In addition to the processing in the first embodiment, the user information acquisition program P1 can execute processing related to acquisition of an identifier and an inquiry to a server. Specific examples of the identifier include a cookie and a mobile advertisement ID (ADID/IDFA), and an advertisement providing server provided by a third party can be considered as an external server that provides the user information. However, a server prepared by a provider of the present information system may be used. In the present embodiment, as the personal information, personal information input by the user in the past, a history of accessed URLs, a user group classified in advance for advertisement transmission, and the like can be considered. In the present embodiment, step S42 of displaying an interface that prompts the user to input personal information may be omitted. The obtained personal information is converted into an attribute information token sequence through certain processing and is passed to subsequent processing.

In this manner, by acquiring the attribute information of the user using the identifier of the user terminal 30, it is possible to acquire various attribute information of the user while saving time and effort of input by the user. The calculation unit 110 converts the acquired attribute information into the user information token and uses the user information token for subsequent processing.

### Fifth Embodiment

In the present embodiment, an embodiment common to the first to fourth embodiments will be omitted, and only portions different from the first to fourth embodiments will be described. In addition, the same names and reference numerals as those of the first to fourth embodiments will be used for description.

In the present embodiment, in step S42 of displaying an interface that prompts the user to input attribute information, an interface to which an input section that permits linking with the social networking service (SNS) is added is displayed. The user information acquisition program P1 further includes a program for acquiring personal information from an account of the linked SNS, and the user information acquisition unit 111 acquires information related to the user from the account of the SNS. In the present embodiment, as the personal information, personal information input by the user in the past, an action on the SNS such as a follow status or a post, a user group classified in advance for advertisement transmission, or the like can be considered. In the information processing apparatus 10, various personal information is acquired from the linked SNS, and is converted into a user information token and used for subsequent processing.

In this way, by acquiring the attribute information of the user by using the information obtained by the linked SNS, it is possible to acquire various attribute information of the user while saving time and effort of input by the user.

### Sixth Embodiment

In the present embodiment, an embodiment common to the first to fifth embodiments will be omitted, and only portions different from the first to fifth embodiments will be described. In addition, the same names and reference numerals as those of the first to fifth embodiments will be used for description.

In the present embodiment, the user information acquisition unit 111 acquires the attribute information of the user on the basis of the data stored in the user terminal 30 or the data stored in association with the application included in the user terminal 30. In step S42 of displaying an interface that prompts the user to input attribute information, an interface with an added input section that permits access to data stored in the user terminal 30 or data stored in association with an application on the user terminal 30 is displayed. The user information acquisition program P1 further includes a program for acquiring personal information from data stored in the user terminal 30 or the application. In the present embodiment, as the attribute information, an image, position information, language information, information input to a predetermined application in the past, and the like can be considered. The calculation unit 110 converts the acquired attribute information into the user information token and uses the user information token for subsequent processing.

In this way, by acquiring the attribute information of the user from the already accumulated data, it is possible to acquire various attribute information of the user while saving time and effort of input by the user.

### Seventh Embodiment

In the present embodiment, an embodiment common to the first to sixth embodiments will be omitted, and only portions different from the first to sixth embodiments will be described. In addition, e names and reference numerals as those of the first to sixth embodiments will be used for description.

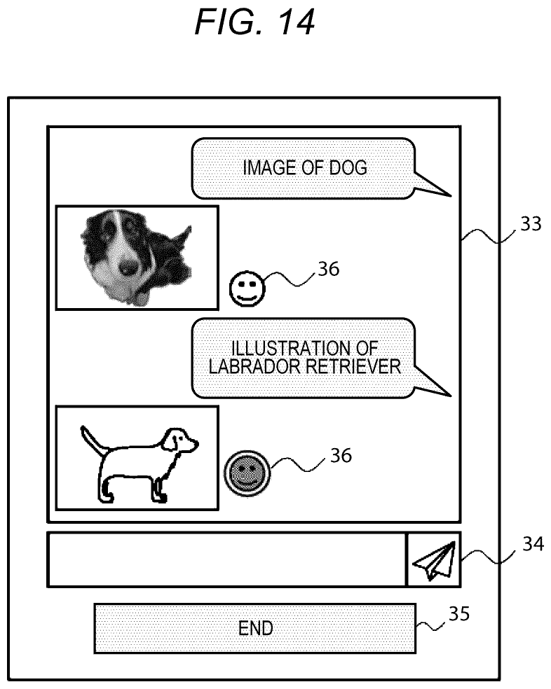

In the present embodiment, the interface control unit 112 can display the generated image generated by the image generation unit 1132 on the user terminal 30 together with an evaluation input section 36 for inputting the evaluation on the generated image by the user. The history display section 33 is provided with the evaluation input section 36 for evaluating the generated image. FIG. 14 is an example of an image generation interface displayed on the user terminal 30 in the present embodiment. In the drawing, the evaluation input section 36 is displayed next to the generated image. The evaluation input section 36 is, for example, a high evaluation button or a save button for saving the generated image on the user terminal 30 or the cloud. The information processing apparatus 10 causes the storage unit 20 to store which generated image the high evaluation button or the save button has been selected for as the behavior history of the user. Since the generated image in which the high evaluation button or the save button is selected is considered to be an output when the user is satisfied with the generation result, the personalized feature amount model training program P5 can train the personalized feature amount model for the generated image in which the high evaluation button or the save button is selected instead of the final prompt token sequence.

In this manner, by displaying the interface capable of inputting the evaluation of the user for the generated image and selecting the data to be used for training of the personalized feature amount model training program P5 on the basis of the evaluation of the user, the accuracy of the personalized feature amount model learning can be improved.

### Eighth Embodiment

In the present embodiment, an embodiment common to the first to seventh embodiments will be omitted, and only portions different from the first to seventh embodiments will be described. In addition, the same names and reference numerals as those of the first to seventh embodiments will be used for description.

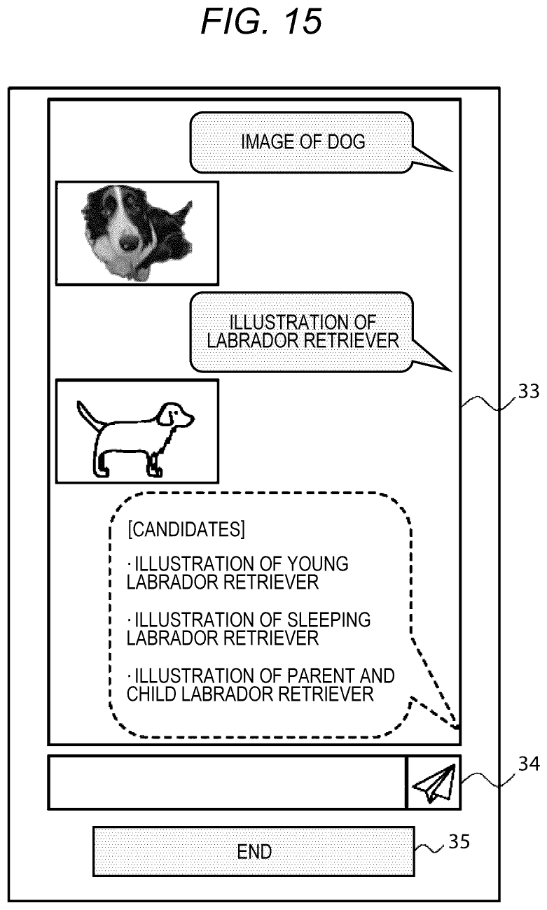

In the present embodiment, the interface control unit 112 can display the inferred second feature amount on the user terminal 30. FIG. 15 is an example of an image generation interface displayed on the user terminal 30 in the present embodiment. In the history display section 33, the second feature amount is displayed near the prompt input section 34 as a candidate for the feature amount to be input next. At this time, instead of inputting text into the prompt input section 34, the user can select a desired candidate from the displayed candidates. Although a plurality of candidates are displayed in the drawing, only one candidate may be displayed. When one of the candidates is selected by the user, the personalized image generation program P3 executes processing with the token sequence related to the selected candidate as an input. Furthermore, the information processing apparatus 10 may cause the storage unit 20 to store which candidate has been selected as the behavior history of the user. In this case, it is possible to perform training by the personalized feature amount model training program P5 by weighting so that the selected candidate is more likely to be output in the subsequent personalized feature amount inference program P31 and the unselected candidate is less likely to be output in the subsequent personalized feature amount inference program P31.

As described above, by displaying the second feature amount inferred by the personalized feature amount inference program P31 as a candidate and allowing the user to select the candidate, feedback from the user with respect to the inference result of the personalized feature amount inference program P31 can be obtained, so that the accuracy of the personalized feature amount model learning can be improved.

### Ninth Embodiment

In the present embodiment, an embodiment common to the first to eighth embodiments will be omitted, and only portions different from the first to eighth embodiments will be described. In addition, the same names and reference numerals as those of the first to eighth embodiments will be used for description.

In the present embodiment, when the generated image generated by the image generation unit 1132 is the feature amount input by the user after being displayed on the user terminal 30, the feature amount other than the feature amount (final feature amount) input last by the user is included in the behavior history and used for training of the personalized feature amount model. The information processing apparatus 10 stores not only the first feature amount and the final feature amount but also part or all of the time-series data of the prompt input by the user in the storage unit 20 as the behavior history of the user.

In this manner, by causing the storage unit 20 to store the prompt input between the first feature amount and the final feature amount together and using the prompt for training the personalized feature amount model by the personalized feature amount model training program P5, it is possible to construct the personalized feature amount model in consideration of the context.

### Tenth Embodiment

In the present embodiment, an embodiment common to the first to ninth embodiments will be omitted, and only portions different from the first to ninth embodiments will be described. In addition, the same names and reference numerals as those of the first to ninth embodiments will be used for description.

In the present embodiment, a generation model used for image generation is a Transformer, and the Transformer has several stages of encoders. The first prompt token sequence and the attribute information token sequence are input to different encoders, and the input and output of the decoder are used for beam search of the final prompt token sequence. Furthermore, by adopting the beam search also for the training of the personalized feature amount model by the personalized feature amount model training program P5, it is possible to infer the input prompt token sequence for a more natural input prompt.

### Eleventh Embodiment

In the present embodiment, an embodiment common to the first to tenth embodiments will be omitted, and only portions different from the first to tenth embodiments will be described. In addition, e names and reference numerals as those of the first to tenth embodiments will be used for description.

In the present embodiment, the personalized feature amount model can be trained by dividing a person included in the background information database into a plurality of user groups and aggregating the feature amounts co-occurring in each user group. Specifically, the personalized feature amount model training program P5 includes a program that divides the attribute information token sequence into a plurality of user groups and aggregates co-occurring tokens for each user group. As a method of dividing the user group, a rule-based method, a method using clustering, or the like can be considered. In the personalized feature amount model trained in this way, in addition to the functions of the models in other embodiments, the attribute information token sequence can be classified and stored for each user group, or the weighting based on the aggregation result of the first prompt token sequence co-occurring in each user group can be performed. By using such a personalized feature amount model, when the personalized feature amount inference program P31 is executed, the user group to which the user belongs is discriminated, and the personalized prompt token sequence in which the co-occurring token is compensated for on the basis of the user group can be output. As a result, the accuracy of the inference result by the personalized feature amount inference program P31 can be improved. In the present embodiment, the method of dividing the user group has been described, but the actual embodiment is not limited thereto, and other methods indicating effectiveness as a suggestion method in the search field can also be applied to training of the personalized feature amount model and inference of the personalized feature amount.

Although some embodiments have been described above, the present invention is not limited to the above-described embodiments as they are, and the components can be modified and embodied in the implementation stage without departing from the gist thereof. For example, the embodiment described above has been described only in a case where the generation model is an image, but a person skilled in the art can easily conceive that a similar method can be applied to a case where text, audio, or the like is generated by appropriately replacing the model. In addition, various inventions can be formed by appropriately combining or deleting a plurality of constituent elements disclosed in the above embodiments.

### Supplementary Note 1

An information processing apparatus including a personalized feature inference unit configured to infer a second prompt token sequence related to a second feature amount on the basis of data related to background information of a person having an attribute close to an attribute of a first user, among data included in a background information database accumulating background information in which attribute information related to an attribute of a person, a feature amount input by the person, and a behavior history related to an action of the person with respect to a product generated on the basis of the feature amount are associated with each other, and a first feature amount input by the first user.

### Supplementary Note 2

The information processing apparatus according to supplementary note 1, further including:

a user information acquisition unit configured to acquire attribute information of the first user; and an image generation unit configured to be capable of generating an image using the second feature amount as an input prompt.

### Supplementary Note 3

The information processing apparatus according to supplementary note 1 or 2, in which the personalized feature amount inference unit infers the personalized prompt token sequence in which personalized feature amount is tokenized by selecting a token sequence on the basis of a likelihood sequence of the second prompt token sequence output from an attribute information token sequence in which attribute information of the first user is tokenized and a first prompt token sequence in which the first feature amount is tokenized.

### Supplementary Note 4

The information processing apparatus according to any one of supplementary notes 1 to 3, in which the personalized feature amount inference unit uses a personalized feature amount model when inferring the second prompt token sequence from the first feature amount, and the personalized feature amount model is capable of being trained on the basis of background information in which attribute information of the first user, the first feature amount, and a behavior history of the first user with respect to a product generated on the basis of the first feature amount or the second feature amount are associated with each other.

### Supplementary Note 5

The information processing apparatus according to supplementary note 4, in which

the personalized feature amount model is capable of being trained by inferring the second prompt token sequence on the basis of an attribute information token sequence obtained by tokenizing the attribute information of the first user and a first prompt token sequence obtained by tokenizing the first feature amount, calculating a cross entropy loss related to the second prompt token sequence, and updating the personalized feature amount model using an error backpropagation method.

### Supplementary Note 6

The information processing apparatus according to any one of supplementary notes 2 to 5, in which

the user information acquisition unit acquires an identifier from a terminal operated by the first user, and inquires of an external server holding information related to the identifier to acquire the attribute information of the first user.

### Supplementary Note 7

The information processing apparatus according to any one of supplementary notes 2 to 6, in which

the user information acquisition unit acquires information related to the first user from an account of a social network service (SNS).

### Supplementary Note 8

The information processing apparatus according to any one of supplementary notes 2 to 7, in which

the user information acquisition unit acquires the attribute information of the first user on a basis of data stored in a terminal operated by the first user or data stored in an application included in the terminal.

### Supplementary Note 9

The information processing apparatus according to any one of supplementary notes 2 to 8, further including

an interface control unit that causes a generated image generated by the image generation unit to be displayed on a terminal operated by the first user together with an evaluation input section for inputting evaluation on the generated image by the first user.

### Supplementary Note 10

The information processing apparatus according to any one of supplementary notes 2 to 9, further including

an interface control unit configured to display the second feature amount on a terminal operated by the first user.

### Supplementary Note 11

The information processing apparatus according to supplementary note 4 or 5, further including

an image generation unit capable of generating an image with the second feature amount as an input prompt, in which

in the personalized feature amount model, a feature amount input by the first user after a generated image generated by the image generation unit is displayed on a terminal operated by the first user is set as a behavior history of the first user.

### Supplementary Note 12

The information processing apparatus according to any one of supplementary notes 2 to 11, in which

the image generation model used by the image generation unit is capable of performing beam search during training and inference of the second feature amount.

### Supplementary Note 13

The information processing apparatus according to supplementary note 4 or 5, in which

the personalized feature amount model is capable of being trained by dividing the person included in the background information database into a plurality of user groups and aggregating feature amounts co-occurring in each of the user groups.

### Supplementary Note 14

An information processing apparatus including a personalized feature amount inference unit configured to infer a second feature amount by adding attribute information of a first user to a first feature amount input by the first user.

### Supplementary Note 15

A program for causing an information processing apparatus

to infer a second prompt token sequence related to a second feature amount on the basis of data related to background information of a person having an attribute close to an attribute of a first user, among data included in a background information database that accumulates background information in which attribute information related to an attribute of a person, a feature amount input by the person, and a behavior history related to an action of the person with respect to a product generated on the basis of the feature amount are associated with each other, and a first feature amount input by the first user.

### Supplementary Note 16

A feature amount inference method including a step of, by a personalized feature amount inference unit, inferring a second prompt token sequence related to a second feature amount on the basis of data related to background information of a user having an attribute close to an attribute of a first user, among data included in a background information database accumulating background information in which attribute information related to an attribute of a person, a feature amount input by the person, and a behavior history related to an action of the person on a product generated on the basis of the feature amount are associated with each other, and a first feature amount input by the first user.

What is claimed is:

1. An information processing apparatus comprising a personalized feature amount inference unit configured to infer a second prompt token sequence related to a second feature amount on the basis of data related to background information of a person having an attribute close to an attribute of a first user, among data included in a background information database accumulating background information in which attribute information related to an attribute of a person, a feature amount input by the person, and a behavior history related to an action of the person with respect to a product generated on the basis of the feature amount are associated with each other, and a first feature amount input by the first user.

2. The information processing apparatus according to claim 1, further comprising:
a user information acquisition unit configured to acquire attribute information of the first user; and
an image generation unit configured to be capable of generating an image using the second feature amount as an input prompt.

3. The information processing apparatus according to claim 1, wherein
the personalized feature amount inference unit infers the personalized prompt token sequence in which personalized feature amount is tokenized by selecting a token sequence on the basis of a likelihood sequence of the second prompt token sequence output from an attribute information token sequence in which attribute information of the first user is tokenized and a first prompt token sequence in which the first feature amount is tokenized.

4. The information processing apparatus according to claim 1, wherein
the personalized feature amount inference unit uses a personalized feature amount model when inferring the second prompt token sequence from the first feature amount, and
the personalized feature amount model is capable of being trained on the basis of background information in which attribute information of the first user, the first feature amount, and a behavior history of the first user with respect to a product generated on the basis of the first feature amount or the second feature amount are associated with each other.

5. The information processing apparatus according to claim 4, wherein
the personalized feature amount model is capable of being trained by inferring the second prompt token sequence on the basis of an attribute information token sequence obtained by tokenizing the attribute information of the first user and a first prompt token sequence obtained by tokenizing the first feature amount, calculating a cross entropy loss related to the second prompt token sequence, and updating the personalized feature amount model using an error backpropagation method.

6. The information processing apparatus according to claim 2, wherein
the user information acquisition unit acquires an identifier from a terminal operated by the first user, and inquires of an external server holding information related to the identifier to acquire the attribute information of the first user.

7. The information processing apparatus according to claim 2, wherein
the user information acquisition unit acquires information related to the first user from an account of a social network service (SNS).

8. The information processing apparatus according to claim 2, wherein
the user information acquisition unit acquires the attribute information of the first user on a basis of data stored in a terminal operated by the first user or data stored in an application included in the terminal.

9. The information processing apparatus according to claim 2, further comprising
an interface control unit that causes a generated image generated by the image generation unit to be displayed on a terminal operated by the first user together with an evaluation input section for inputting evaluation on the generated image by the first user.

10. The information processing apparatus according to claim 2, further comprising
an interface control unit configured to display the second feature amount on a terminal operated by the first user.

11. The information processing apparatus according to claim 4, further comprising
an image generation unit capable of generating an image with the second feature amount as an input prompt, wherein
in the personalized feature amount model, a feature amount input by the first user after a generated image generated by the image generation unit is displayed on a terminal operated by the first user is set as a behavior history of the first user.

12. The information processing apparatus according to claim 2, wherein
the image generation model used by the image generation unit is capable of performing beam search during training and inference of the second feature amount.

13. The information processing apparatus according to claim 4, wherein
the personalized feature amount model is capable of being trained by dividing the person included in the background information database into a plurality of user groups and aggregating feature amounts co-occurring in each of the user groups.

14. An information processing apparatus comprising
a personalized feature amount inference unit configured to infer a second feature amount by adding attribute information of a first user to a first feature amount input by the first user.

15. A feature amount inference method comprising
a step of, by a personalized feature amount inference unit, inferring a second prompt token sequence related to a second feature amount on the basis of data related to background information of a user having an attribute close to an attribute of a first user, among data included in a background information database accumulating background information in which attribute information related to an attribute of a person, a feature amount input by the person, and a behavior history related to an action of the person on a product generated on the basis of the feature amount are associated with each other, and a first feature amount input by the first user.
